(19) United States
(12) Patent Application Publication
(10) Pub. No.: US 2019/0191956 A1
(43) Pub. Date: Jun. 27, 2019

(54) WIPING DEVICE

(71) Applicant: CARL FREUDENBERG KG, Weinheim (DE)

(72) Inventors: Uwe DINGERT, Abtsteinach (DE); Norbert WEI, Weinheim (DE)

(21) Appl. No.: 16/327,412

(22) PCT Filed: Aug. 18, 2017
(86) PCT No.: PCT/EP2017/070967

§ 371 Date: Feb. 22, 2019

(30) Foreign Application Priority Data
Aug. 25, 2016 (IT) 202016000087147

(51) Int. Cl. A47L 13/20; A47L 13/42; B25G 1/04

(52) U.S. Cl. CPC A47L 13/20; B25G 1/04; A47L 13/42

(57) ABSTRACT

Wiping device (1), comprising a shaft (2) and a wiping plate (4) connected to the shaft (2) via an articulation (3), a wiping material (5) being arranged on the wiping plate (4) on the side facing the floor to be cleaned, it being possible to set the wiping plate (4) in rotation along with the wiping material (5) for rinsing and for removing excess cleaning fluid, a spindle drive (6) being assigned to the shaft (2), the spindle drive (6) comprising a spindle (7) and a sleeve (8), the spindle (7) being integrated into the shaft (2).

The invention relates to a wiping device, comprising a shaft and a wiping plate connected to the shaft via an articulation, a wiping material being arranged on the wiping plate on the side facing the floor to be cleaned, it being possible to set the wiping plate in rotation along with the wiping material for rinsing and for removing excess cleaning fluid, a spindle drive being assigned to the shaft.

A wiping device of this type is known for example from WO 2016/011829 A1. The previously known wiping device comprising a two-part shaft, a freewheel spindle drive being arranged in a first shaft element. This shaft portion is provided with an articulation to which the wiping plate is linked.

The second shaft portion is formed hollow, and has on the inner periphery a thread structure which is engaged with the spindle drive. For this purpose, ball bodies are arranged on the spindle drive, which engage in the thread structure of the second shaft portion. If the second shaft portion is pressed in the direction towards the first shaft portion, the balls slide along on the thread structure and thus set the first shaft portion having the wiping plate fixed therein in rotation. As a result, excess cleaning fluid is spun out of the wiping cover.

A drawback of the previously known wiping device is that at least the second shaft portion is relatively voluminous. Further, the second shaft portion is expensive to manufacture.

The object of the invention is to provide a wiping device of the type mentioned at the outset which is cost-effective to manufacture.

This object is achieved by the features of claim 1. The dependent claims refer to advantageous embodiments.

The wiping device according to the invention comprises a shaft and a wiping plate connected to the shaft via an articulation, a wiping material being arranged on the wiping plate on the side facing the floor to be cleaned, it being possible to set the wiping plate in rotation along with the wiping material for rinsing and for removing excess cleaning fluid, a spindle drive being assigned to the shaft, the spindle drive comprising a spindle and a sleeve, the spindle being integrated into the shaft.

In the embodiment according to the invention, the spindle drive thus forms part of the shaft, and so it is arranged in the wiping device in a particularly compact manner. This configuration results in a continuous shaft, which extends from the articulation to the handle on the opposite side. The shaft can be formed particularly robust, in such a way that even firmly adhering soiling can be loosened by a large force input at the shaft. Because the spindle drive is part of the shaft, the sleeve can also be formed with a small diameter. Overall, this results in a weight reducing and in an improved handling of the wiping device. Further, saving on material results in a saving on costs.

The spindle may have ball bodies and the sleeve may have an internal thread. The spindle may further have a freewheel. In a preferred embodiment, the spindle is formed from plastics material and manufactured for example by injection-moulding. The spindle is substantially cylindrical, and has depressions, in which ball bodies made of metal material are laid, distributed over the periphery. The ball bodies engage in the internal thread of the sleeve, in such a way that the spindle is set in rotation along with the ball bodies when the sleeve is moved in translation. To prevent the direction of rotation of the spindle from changing when the sleeve is moved in the other direction, a freewheel is provided. As a result, rotational energy can only be introduced into the spindle in one direction. In turn, the spindle is rotationally engaged with the shaft, in such a way that the shaft is set in rotation as a whole along with the wiping plate fixed thereto. The sleeve likewise preferably consists of plastics material and is likewise manufactured by injection moulding.

The internal thread of the sleeve may have a variable pitch. This makes it possible to implement various transmission ratios in the spindle drive. In an advantageous embodiment, the pitch is greater on one side of the sleeve than on the other side. In this case, the large pitch acts at the start of the translational movement, in such a way that the shaft can easily be set in rotation. By reducing the pitch, a higher spin speed is achieved.

At one end, the shaft may have a handle which is rotatably connected to the shaft. As a result, the shaft can be held in place during the spinning out, and this improves the ease of handling. For the rotatable connection, a ball bearing or a sliding bearing may be provided.

The sleeve is preferably externally formed as a handle. As a result, particularly ergonomic spinning-out of the wiping device is possible. The sleeve can thus be provided with a profiling, for example by way of annular elevations and depressions.

In an advantageous embodiment, the shaft comprises two shaft portions which are interconnected via the spindle. For this purpose, the spindle may have cylindrical portions on both sides which can be plugged into the tubularly formed shaft portions. If the shaft portions are formed from metal, a particularly rigid connection occurs if the shaft portions are formed with plastic deformation in portions. If the shaft portions are formed from a plastics material, the shaft portions can be interconnected positively with the spindle, for example by rotational welding.

The embodiment according to the invention of the wiping device, comprising the spindle integrated into the shaft, makes it possible for at least one shaft portion to be telescopic. As a result, the length of the shaft can be adapted to the user. Further, the shaft can be compactly reduced in size so as to be better able to store it. For this purpose, at least one shaft portion is divided at least in two, one part being pluggable into the other part. Via a lock, the shaft portion can thus be locked at the desired length.

Further, at least one shaft portion may be formed in multiple parts. The transport volume is reduced if the shaft can be disassembled. For this purpose, for example the two shaft portions may be detachably connected to the spindle. This can take place via a screw connection. In this context, the shaft is mounted by screwing the shaft portions to the spindle. There is a further reduction in the transport volume if the shaft portions are also in multiple parts. There too, a screw connection which makes simple mounting possible may be provided.

The sleeve may be provided with a spring so as to be able to return automatically to an initial position. In this embodiment, it is merely necessary to move the sleeve in one direction. Once this has been done, the sleeve returns automatically to an initial position.

Preferably, the wiping plate is linked to the shaft in an articulated manner. This improves the maneuverability of the wiping device and the ease of reaching hard-to-access regions.

Preferably, the articulation is lockable. For this purpose, a mean is provided which stiffens or blocks the articulation when the wiping plate can be set in rotation. As a result of the locking, the rotational energy introduced into the shaft can be transmitted in its entirety to the wiping plate, improving the wringing-out performance. Further, it is possible to prevent vibrations or oscillations occurring as a result of movements of the articulation.

Some embodiments of the wiping device according to the invention are explained in greater detail in the following with reference to the drawings, which show, in each case schematically:

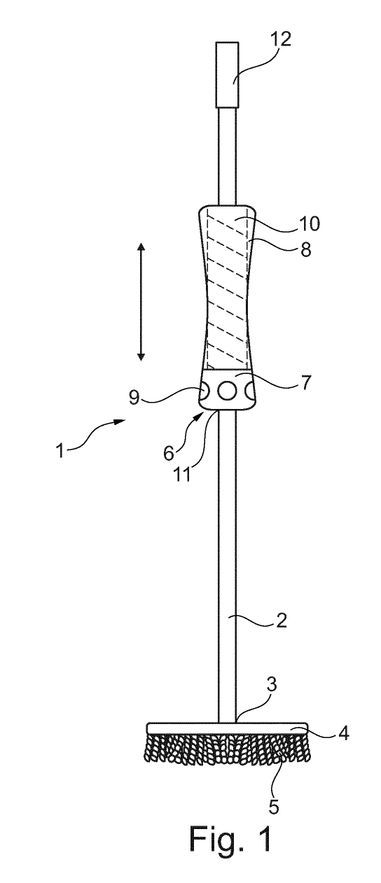

FIG. 1 the wiping device in section;

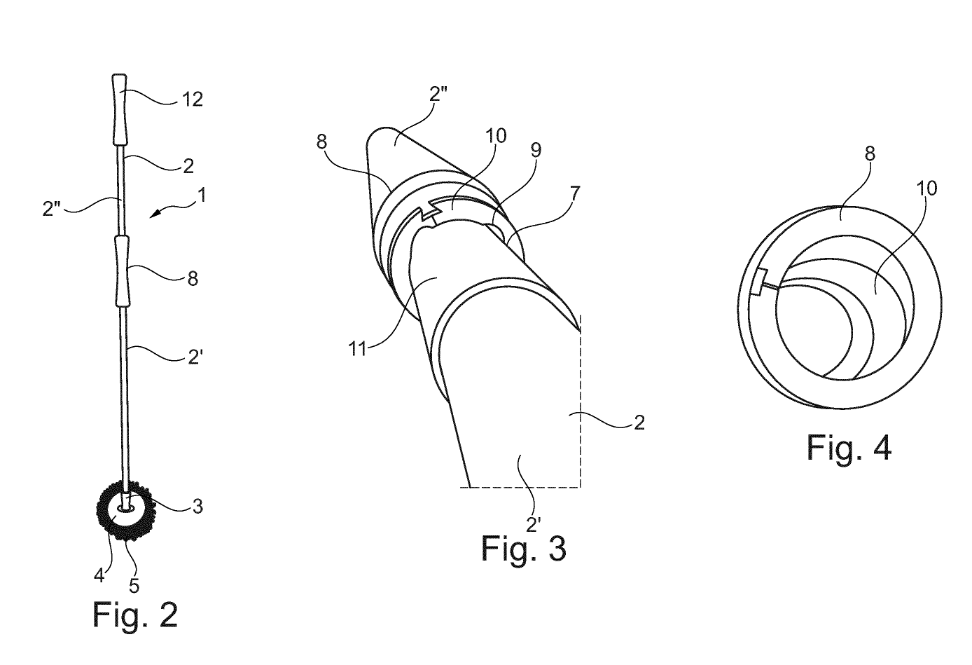

FIG. 2 the wiping device;

FIG. 3 the spindle drive in detail;

FIG. 4 the sleeve in detail.

The drawings show a wiping device 1, comprising a shaft 2 and a wiping plate 4 connected to the shaft 2 via an articulation 3. A wiping material 5 is arranged on the wiping plate 4 on the side facing the floor to be cleaned.

The wiping material 5 consists of textile material, and may be provided with a fringe, likewise made of textile material. The wiping material 5 may be fixed to the wiping plate 4 via a hook-and-loop fastening or in a positive fit. For example, the wiping material 5 may be formed sack-shaped and be provided with a rubber band at the open end. The wiping material 5 encloses the wiping plate 4 at least in part on the side facing away from the floor.

The wiping device 1 is formed in such a way that the wiping plate 4 can be set in rotation along with the wiping material 5 for rinsing and for removing excess cleaning fluid. For this purpose, a spindle drive 6 is assigned to the shaft 2. The spindle drive 6 comprises a spindle 7 and a sleeve 8, the spindle 7 being integrated into the shaft 2. Preferably, the shaft 2 comprises two shaft portions 2′, 2″, which are formed tubular and consist of metal material. The two shaft portions 2′, 2″ are interconnected via the spindle 7. For this purpose, the spindle 7 has on both sides axially projecting cylindrical portions, onto which the shaft portions 2′, 2″ are plugged. By way of plastic deformation of the shaft portions 2′, 2″ in the region of the cylindrical portions, the shaft portions 2′, 2″ are connected to the spindle 7 in a positive fit. Alternatively, the shaft portions 2′, 2″ may be detachably connected to the spindle, for example by way of a screw connection. Further, the shaft portions 2′, 2″ may also be formed in multiple parts.

The spindle 7 is formed from plastics material, preferably polyamide (PA), and manufactured by injection-moulding. Depressions, in which ball bodies 9 made of metal material are laid, are formed on the outer periphery of the spindle 7.

The sleeve 8 consists of plastics material and is manufactured by injection-moulding. The sleeve 8 is formed tubular and has on the inner periphery an internal thread 10, which is formed in such a way that the ball bodies 9 can slide along in the internal thread. The internal thread 10 may have a variable pitch.

A freewheel 11 is integrated into the spindle 7, in such a way that rotational energy can be introduced from the sleeve 8 into the shaft 2 in only one direction of rotation.

At one end, the shaft 2 has a handle 12, which is rotatably connected to the shaft 2.

The sleeve 8 is externally formed as a handle, and has a plurality of annular elevations and depressions.

The wiping plate 4 is linked to the shaft 2 in an articulated manner, the articulation 3 being lockable. In this context, locking takes place during the wringing-out, in such a way that the rotational energy of the shaft 2 can be transmitted in its entirety to the wiping plate 4.

In an advantageous embodiment, the sleeve 8 is provided with a spring, in such a way that the sleeve 8 can return to an initial position automatically.

In a further advantageous embodiment, at least one shaft portion 2′, 2″ is telescopic.

What is claimed is:

1.-12. (canceled)

13. A wiping device, comprising a shaft and a wiping plate connected to the shaft via an articulation, a wiping material being arranged on the wiping plate on the side facing the floor to be cleaned, it being possible to set the wiping plate in rotation along with the wiping material for rinsing and for removing excess cleaning fluid, a spindle drive being assigned to the shaft, the spindle drive comprising a spindle and a sleeve, the spindle being integrated into the shaft, wherein the shaft comprises two shaft portions which are interconnected via the spindle.

14. The wiping device according to claim 13, wherein the spindle has ball bodies.

15. The wiping device according to claim 13, wherein the sleeve is formed tubular and has an internal thread.

16. The wiping device according to claim 15, wherein the internal thread has a variable pitch.

17. The wiping device according to claim 13, wherein the spindle has a freewheel.

18. The wiping device according to claim 13, wherein, at one end, the shaft has a handle which is rotatably connected to the shaft.

19. The wiping device according to claim 13, wherein the sleeve is externally formed as a handle.

20. The wiping device according to claim 13, wherein at least one shaft portion is telescopic.

21. The wiping device according to claim 13, wherein at least one shaft portion is formed in multiple parts.

22. The wiping device according to claim 13, wherein the sleeve is provided with a spring so as to be able to return automatically to an initial position.

23. The wiping device according to claim 22, wherein the articulation is lockable.

24. A wiping device, comprising a shaft and a wiping plate connected to the shaft via an articulation, a wiping material being arranged on the wiping plate on the side facing the floor to be cleaned, it being possible to set the wiping plate in rotation along with the wiping material for rinsing and for removing excess cleaning fluid, a spindle drive being assigned to the shaft, the spindle drive comprising a spindle and a sleeve, characterised in that the spindle is integrated into the shaft.

25. The wiping device of claim 24, wherein the articulation is lockable.

26. The wiping device according to claim 24, wherein the sleeve is tubular and has an internal thread.

27. The wiping device according to claim 26, wherein the internal thread has a variable pitch.

28. The wiping device according to claim 24, wherein the shaft comprises two shaft portions which are interconnected via the spindle.

29. The wiping device according to claim 28, wherein at least one shaft portion is telescopic.

30. The wiping device according to claim 24, wherein the spindle has a freewheel.

31. The wiping device according to claim 24, wherein the spindle has ball bodies.
